(19) United States
(12) Patent Application Publication
(10) Pub. No.: US 2021/0204284 A1
(43) Pub. Date: Jul. 1, 2021

(54) APPARATUS AND METHOD OF VEHICLE-TO-EVERYTHING COMMUNICATION OF SAME

(71) Applicant: GUANGDONG OPPO MOBILE TELECOMMUNICATIONS CORP., LTD., Dongguan (CN)

(72) Inventors: Huei-Ming LIN, South Yarra (AU); Zhenshan ZHAO, Dongguan (CN); Qianxi LU, Dongguan (CN)

(21) Appl. No.: 17/202,287

(22) Filed: Mar. 15, 2021

Related U.S. Application Data
(63) Continuation of application No. PCT/CN2018/107624, filed on Sep. 26, 2018.

(51) Int. Cl. H04W 72/04; H04W 4/40

(52) U.S. Cl. CPC H04W 72/0446; H04W 92/18; H04W 72/0406; H04W 4/40

(57) ABSTRACT

An apparatus and a method of vehicle-to-everything (V2X) communication of same are provided. The apparatus is a group header of a unicast session or a groupcast session. The method includes determining sidelink (SL) resource configuration details, broadcasting, to at least one group member user equipment (UE) of the unicast session or the groupcast session, the SL resource configuration details over a new radio sidelink (NR-SL) interface, allocating, to the at least one group member UE of the unicast session or the groupcast session, at least one set of periodic occurring SL resources over the NR-SL interface, and reserving the at least one set of periodic occurring SL resources over the NR-SL interface from at least another surrounding UE.

### CROSS REFERENCE TO RELATED APPLICATION(S)

This application is a continuation of International Application No. PCT/CN2018/107624, filed on Sep. 26, 2018, the entire disclosure of which is incorporated herein by reference.

### TECHNICAL FIELD

The present disclosure relates to the field of communication systems, and more particularly, to an apparatus and a method of vehicle-to-everything (V2X) communication of same.

### BACKGROUND

In an evolution of intelligent transportation systems (ITS), more advanced applications and services that require direct vehicle-to-everything (V2X) communication to increase safety of road users, improve efficiency of traffic flow, minimize environmental impact and enhance road travel experience for passengers are constantly being developed by an automotive industry and regulation bodies around the world. In order to assist achieving these ITS objectives, wireless standards organizations such as institute of electrical and electronic engineering (IEEE) and 3rd generation partnership project (3GPP) are exploiting new technologies to enable faster and more reliable transfer of V2X data between different nodes and user equipment (UE) on the road. One way to improve the efficiency and reliability of V2X communication, compared to an existing LTE-V2X system, the next generation of technology, namely new radio V2X (NR-V2X), is looking to support unicast and groupcast type of transmissions at the physical layer.

Different from broadcast type of transmission, mechanisms for establishing a connection session for a group of communicating UEs, maintaining the connection session, and ensuring a target link performance achieved for the connection session need to be introduced for unicast and groupcast types of transmission. Since V2X data traffic from each group member UE in a unicast/groupcast session can occur at any time and most of V2X transmissions over NR sidelink interface are likely to be confined within same set of radio resources and carriers, transmission (Tx) collisions between different UEs or even between group member UEs of a same unicast/groupcast session can happen if there is no central control and management of sidelink (SL) resource usage. Consequently, reliability of sidelink communication will be degraded. In addition, with no coordination of transmission timings between group member UEs, it is possible for a UE to have miss reception of V2X messages from other group member UEs due to half-duplex limitation (i.e. not being able to “hear” from other UEs while transmitting on a same carrier). If transmission rate of the UE is high, the half-duplex limitation, i.e., hear-ability problem, is even more severe. As such, a centralized SL resource coordination and scheduling from a group header in a unicast/groupcast session would be necessary

### SUMMARY

In a first aspect of the present disclosure, an apparatus in a vehicle-to-everything (V2X) communication system is provided. The apparatus is a group header of a unicast session or a groupcast session and includes a memory, a transceiver, and a processor coupled to the memory and the transceiver. The processor is configured to determine sidelink (SL) resource configuration details, broadcast, to at least one group member user equipment (UE) of the unicast session or the groupcast session, the SL resource configuration details over a new radio sidelink (NR-SL) interface, allocate, to the at least one group member UE of the unicast session or the groupcast session, at least one set of periodic occurring SL resources over the NR-SL interface, and reserve the at least one set of periodic occurring SL resources over the NR-SL interface from at least another surrounding UE.

In a second aspect of the present disclosure, a method of vehicle-to-everything (V2X) communication of an apparatus is provided. The apparatus is a group header of a unicast session or a groupcast session. The method includes determining sidelink (SL) resource configuration details, broadcasting, to at least one group member user equipment (UE) of the unicast session or the groupcast session, the SL resource configuration details over a new radio sidelink (NR-SL) interface, allocating, to the at least one group member UE of the unicast session or the groupcast session, at least one set of periodic occurring SL resources over the NR-SL interface, and reserving the at least one set of periodic occurring SL resources over the NR-SL interface from at least another surrounding UE.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of an apparatus for allocating, to at least one group member user equipment UE of a unicast session or a groupcast session, at least one set of periodic occurring SL resources in a 5th generation new radio (5G-NR) vehicle-to-everything (V2X) communication system according to an embodiment of the present disclosure.

FIG. 2 is a flowchart illustrating a method of 5G-NR V2X communication of an apparatus according to an embodiment of the present disclosure.

FIG. 3 is a schematic diagram of exemplary configurations and structures of control-free and data-free SL resources sets within a sidelink resource pool according to an embodiment of the present disclosure.

FIG. 4 is a schematic diagram of exemplary mapping of control-free and data-free SL resources within a sidelink resource pool according to an embodiment of the present disclosure.

FIG. 5 is a block diagram of a system for wireless communication according to an embodiment of the present disclosure.

### DETAILED DESCRIPTION

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

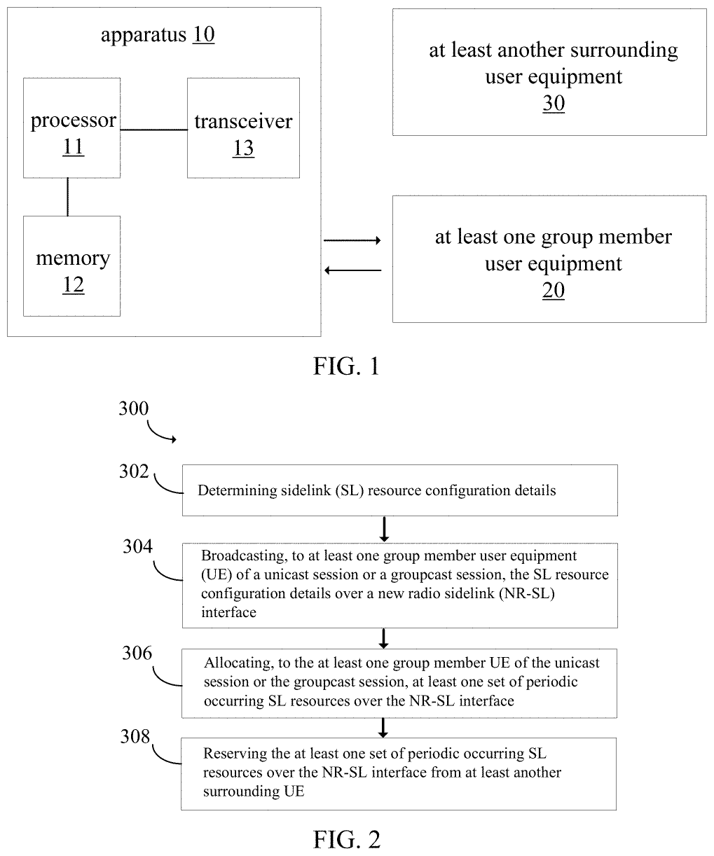

FIG. 1 illustrates that, in some embodiments, an apparatus 10 for allocating, to at least one group member user equipment UE of a unicast session or a groupcast session, at least one set of periodic occurring SL resources in a 5th generation new radio (5G-NR) vehicle-to-everything (V2X) communication system according to an embodiment of the present disclosure. The apparatus 10 may include a processor 11, a memory 12 and a transceiver 13. The processor 11 may be configured to implement proposed functions, procedures and/or methods described in this description. Layers of radio interface protocol may be implemented in the processor 11. The memory 12 is operatively coupled with the processor 11 and stores a variety of information to operate the processor 11. The transceiver 13 is operatively coupled with the processor 11, and transmits and/or receives a radio signal.

The processor 11 may include application-specific integrated circuit (ASIC), other chipset, logic circuit and/or data processing device. The memory 12 may include read-only memory (ROM), random access memory (RAM), flash memory, memory card, storage medium and/or other storage device. The transceiver 13 may include baseband circuitry to process radio frequency signals. When the embodiments are implemented in software, the techniques described herein can be implemented with modules (e.g., procedures, functions, and so on) that perform the functions described herein. The modules can be stored in the memory 12 and executed by the processor 11. The memory 12 can be implemented within the processor 11 or external to the processor 11 in which case those can be communicatively coupled to the processor 11 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) new radio (NR) Release 16 and beyond. UEs are communicated with each other directly via a sidelink interface such as a PC5 interface.

In some embodiments, the apparatus 10 is a group header of a unicast session or a groupcast session. The processor 11 is configured to determine sidelink (SL) resource configuration details, broadcast, to at least one group member user equipment (UE) 20 of the unicast session or the groupcast session, the SL resource configuration details over a new radio sidelink (NR-SL) interface, allocate, to the at least one group member UE 20 of the unicast session or the groupcast session, at least one set of periodic occurring SL resources over the NR-SL interface, and reserve the at least one set of periodic occurring SL resources over the NR-SL interface from at least another surrounding UE 30.

FIG. 2 illustrates a method 300 of 5G-NR V2X communication of the apparatus 10 according to an embodiment of the present disclosure.

The method 300 includes: at block 302, determining sidelink (SL) resource configuration details, at block 304, broadcasting, to at least one group member user equipment (UE) 20 of the unicast session or the groupcast session, the SL resource configuration details over a new radio sidelink (NR-SL) interface, at block 306, allocating, to the at least one group member UE 20 of the unicast session or the groupcast session, at least one set of periodic occurring SL resources over the NR-SL interface, and at block 308, reserving the at least one set of periodic occurring SL resources over the NR-SL interface from at least another surrounding UE 30.

In the embodiment of the present disclosure, the apparatus 10 and the method 300 of vehicle-to-everything (V2X) communication of same aim to solve half-duplex (“hear-ability”) and transmission (Tx) collision problems by allocating, to the at least one group member UE 20 of the unicast session or the groupcast session, the at least one set of periodic occurring SL resources over the NR-SL interface, and reserving the at least one set of periodic occurring SL resources over the NR-SL interface from the at least another surrounding UE 30.

In some embodiments of proposed centralized control of resource request for sidelink (SL) transmissions, the group header 10 can be a BS-type RSU, UE-type RSU, or one of the group member UEs 20 of the unicast/groupcast session. The allocated set of control-free SL resources is for group member UEs 20 to transmit to the group header 10 SL scheduling requests (SL-SR), which can be a UE assistance information (UEAI) and/or a buffer status report (BSR), for requesting SL resources for message data transmissions. The allocated set of control-free SL resources can be periodically occurring that can be configured to match to a latency requirement or message periodicity of expected services/use cases for the unicast/groupcast session.

The SL resource configuration details for allocating one set of control-free SL resources can contain one or more of the following information including a set of parameters defining time and frequency locations of the at least one set of control-free SL resources, a modulation and coding scheme (MCS) level, and/or an SL resource structure type.

Time location: This parameter can be expressed in system frame number (SFN) and/or slot number indicating a starting time or a time offset to a beginning or a next SL resource of the control-free SL resources set.

Periodicity: This parameter can take on one of the following values {3 ms, 5 ms, 10 ms, 20 ms, 25 ms, 50 ms, 100 ms, 500 ms}.

Frequency location: This parameter can be expressed in a sub-channel index number, a starting physical resource block (PRB) index number, or a bit map indicating PRBs or sub-channels within an allocated carrier, a resource pool, and/or a region of a resource pool.

Size of SL resources in frequency domain: If sub-channel index number is indicated for the frequency location, the size of reserved SL resources in the frequency domain is expressed in a number of sub-channels. If the starting PRB index number is indicated for the frequency location, the size of reserved SL resources in the frequency domain is expressed in a number of PRBs.

MCS level: This parameter indicates the modulation order and coding rate that can be used for encoding and baseband modulating SL-SR information to be transmitted via a physical sidelink shared channel (PSSCH) in control-free SL resources. If this parameter is not provided, a fixed or pre-defined MCS level can be used.

SL resource structure type: This parameter can be used to indicate control-free type structure (for carrying SL-SR) or data-free type structure (for carrying SL-SA).

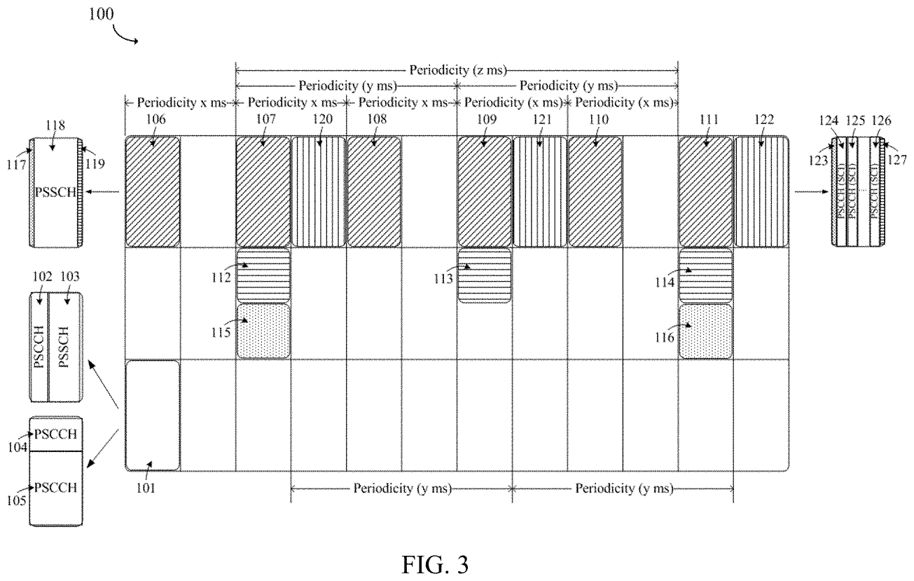

In reference to FIG. 3, group header allocation of 3 sets of periodically occurring control-free SL resources and a proposed common control-free SL resource structure is exemplary illustrated within a sidelink resource pool 100, where an SL resource 101 which is to be used for V2X message transmission can have a time division multiplexed (TDM) structure of physical sidelink control channel (PSCCH) 102 and PSSCH 103 or a frequency division multiplexed (FDM) structure of PSCCH 104 and PSSCH 105.

An allocated first set 106, 107, 108, 109, 110, and 111, a second set 112, 113, and 114 and a third set 115 and 116 of control-free SL resources are configured with an SL resource periodicity of x ms, y ms, and z ms, respectively. A value of x, y, and z can be selected to match to a latency requirement or message periodicity of expected services/use cases for the unicast/groupcast session.

When multiple sets of control-free SL resources are configured, an occurrence of control-free SL resources between different sets can be allocated in a manner such that different sets of control-free SL resources are overlapping in time as much as possible, but not in frequency, as illustrated by time instances (107, 112, 115), (109, 113), and (111, 114, 116). By doing so, the group header will spend less time of receiving SL-SRs from group member UEs and thus giving more time for its own transmissions (if needed). At same time, minimizing half-duplex constraint of miss-reception of sidelink message transmissions from other UEs while a group member UE transmits its own SL-SR.

All control-free SL resources share a common SL resource structure, which includes 3 TDM regions having a first region for automatic gain control (AGC) 117, a second region for PSSCH 118, and followed by a third region for gap 119.

The first region for AGC 117, which is to be used by group member UEs to transmit an AGC training signal and/or other signals, has a length of one OFDM symbol.

The second region for PSSCH 118, which is to be used by group member UEs to transmit SL-SR, has a length of 12 OFDM symbols if the length of an SL resource is equal to one slot long or 26 OFDM symbols if the SL resource length is two slots long.

The third region for gap 119, which is to be left unused/blank and not transmitting any signals or channels by the group header or group member UEs, has a length of one OFDM symbol.

Refer to FIG. 1, in some embodiments, an allocated set of data-free SL resources are for group member UEs 20 to receive from the group header 10 SL scheduling assignments (SL-SA), of SL resources (e.g. 101) for transmitting V2X message data. The SL-SA is to be delivered in a form of sidelink control information (SCI) format, then channel encoded and transmitted in physical sidelink control channel (PSCCH). The allocated set of data-free SL resources can be periodically occurring that can be configured to match to a latency requirement or message periodicity of expected services/use cases for the unicast/groupcast session.

The SL resource configuration details for allocating one set of data-free SL resources can contain one or more of the following information including a set of parameters defining time and frequency locations of the at least one set of data-free SL resources, a modulation and coding scheme (MCS) level, an SL resource structure type, a number of PSCCHs, a PSCCH size, a mapping relationship between the at least one set of control-free SL resources and the at least one set of data-free SL resources, and/or a mapping relationship between the at least one group member UE and the PSCCHs in a data-free SL resource.

Time location: This parameter can be expressed in system frame number (SFN) and/or slot number indicating a starting time or a time offset to a beginning or a next SL resource of the control-free SL resources set.

Periodicity: This parameter can take on one of the following values {3 ms, 5 ms, 10 ms, 20 ms, 25 ms, 50 ms, 100 ms, 500 ms}.

Frequency location: This parameter can be expressed in a sub-channel index number, a starting PRB index number, or a bit map indicating PRBs or sub-channels within an allocated carrier, a resource pool, and/or a region of a resource pool.

Size of SL resources in frequency domain: If sub-channel index number is indicated for the frequency location, the size of reserved SL resources in the frequency domain is expressed in number of sub-channels. If starting PRB index number is indicated for the frequency location, the size of reserved SL resources in the frequency domain is expressed in number of PRBs.

MCS level: This parameter indicates the modulation order and coding rate that can be used for encoding and baseband modulating SL-SA information to be transmitted via PSSCH in data-free SL resources. If this parameter is not provided, a fixed or pre-defined MCS level can be used.

SL resource structure type: This parameter can be used to indicate control-free type structure (for carrying SL-SR) or data-free type structure (for carrying SL-SA).

Number of PSCCHs: This parameter indicates number of PSCCHs in a data-free SL resource and it has a value range set of {1, 2, 3, 4, 6}.

PSCCH size: This parameter indicates the number of OFDM symbols is allocated per PSCCH and it has a value range set of {12, 6, 4, 3, 2}.

Mapping relationship to control-free SL resources sets: If at least one set of control-free SL resources is allocated by the group header, this parameter is used to indicate the mapping relationship between the allocated control-free SL resources and data-free SL resources. In details, this parameter indicates the set(s) of control-free SL resources that are mapped to this set of data-free SL resources.

Mapping relationship to group member UEs: If no control-free SL resource set is allocated by the group header, this parameter is used to indicate the mapping relationship between group member UEs of the unicast/groupcast session and the PSCCHs in a data-free SL resource. For example, UE_1 is mapped to a first PSCCH in a data-free SL resource, UE_2 is mapped to a second PSCCH, and so on (as illustrated in FIG. 3).

In reference to FIG. 3, group header allocation of one set of periodically occurring data-free SL resources and its proposed structure is exemplary illustrated within the sidelink resource pool 100.

An allocated set of data-free SL resources 120, 121, and 122 is configured with an SL resource periodicity of y ms. A value of y can be selected to match to a latency requirement or message periodicity of expected services/use cases for the unicast/groupcast session.

All SL resources within same data-free SL resources set share a common SL resource structure, same the number of PSCCHs and same PSCCH size. The common SL resource structure includes 3 TDM regions having a first region for AGC 123, a second region for one or more PSCCHs 124, 125, 126, and followed by a third region for gap 127.

The first region for AGC 123, which is to be used by the group header to transmit an AGC training signal and/or other signals, has a length of one OFDM symbol.

The second region for one or more PSCCH 124, 125, 126, which is to be used by the group header to transmit SL-SAs, has a minimum length of 12 OFDM symbols if a length of an SL resource is equal to one slot.

The third region for gap 127, which is to be left unused/blank and not transmitting any signals or channels by the group header or group member UEs, has a length of one OFDM symbol.

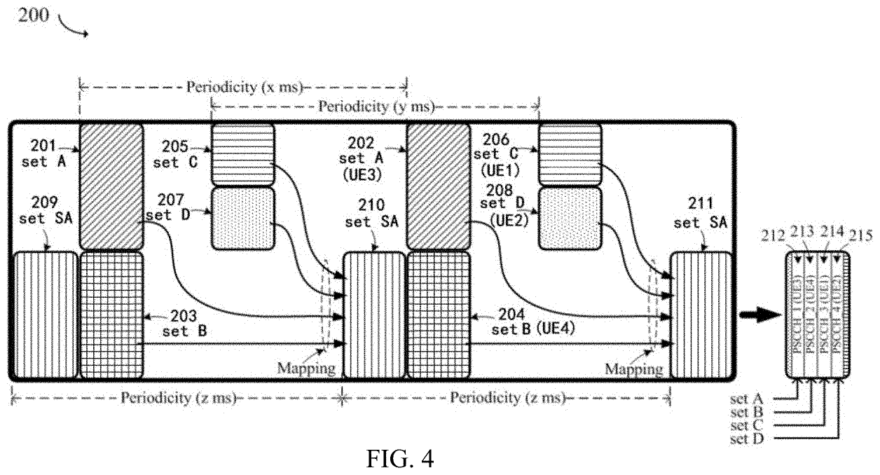

In reference to FIG. 4, four sets of control-free SL resources (set A, set B, set C, and set D) and one set of data-free SL resources (set SA) allocated and reserved by the group header are exemplary illustrated in a sidelink resource pool 200. For the set A control-free SL resources 201 and 202 and the set B control-free SL resources 203 and 204, both sets have same configured SL resource occurring periodicity of x ms. For the set C control-free SL resources 205 and 206 and the set D control-free SL resources 207 and 208, both sets have same configured SL resource occurring periodicity of y ms. For set SA data-free SL resources 209, 210, 211, it has a configured SL resource occurring periodicity of z ms. And since there are four sets of control-free SL resources configured for group member UEs to send SL-SRs to the group header, a number of PSCCHs in data-free SL resources to carry SL-SAs from the group header can also be four 212, 213, 214, 215. The mapping of the control-free SL resources sets (set A, set B, set C, and set D) to the four PSCCHs in the configured data-free SL resources could be done such that a first PSCCH_1 212 is associated with control-free SL resources set A 201 and 202, a second PSCCH_2 213 is associated with control-free SL resources set B 203 and 204, a third PSCCH_3 214 is associated with control-free SL resources set C 205 and 206, and a fourth PSCCH_4 215 is associated with control-free SL resources set D 207 and 208.

Assuming a group member UE3 sends an SL-SR using control-free SL resource 202 of set A, a group member UE4 sends an SL-SR using control-free SL resource 204 of set B, a group member UE1 sends an SL-SR using control-free SL resource 206 of set C, and a group member UE2 sends an SL-SR using control-free SL resource 208 of set D, the unicast/groupcast session group header would base on the described mapping association provide SL-SA responses to UE1, UE2, UE3 and UE4 via PSCCH_3 214, PSCCH_4 215, PSCCH_1 212, and PSCCH_2 213 of data-free SL resource 211, respectively.

In some embodiments of centralized resource request and assignment method, the method aims to solve the above described half-duplex (“hear-ability”) and Tx collision problems by allocating/configuring from the group header a set of control-free SL resources and/or a set of data-free SL resources for sending SL scheduling requests (SL-SRs) from group member UEs and/or providing SL scheduling assignments (SL-SAs) from the group header, respectively.

Benefits of allocating control-free SL resources in NR-V2X unicast/groupcast communications include:

1. The group header is able to ensure SL-SR transmissions from group member UEs will not collide with one another.

2. The group header is able to ensure SL-SRs are transmitted in fixed timings and will not coincide with transmissions from the group header, so that SL-SRs are always “hear-able” by the group header.

3. The group header is also able to ensure the transmitted SL-SRs do not coincide with message data transmissions from other group member UEs, and thus resolving the half-duplex problem of a group member UE not being able to hear other UEs' messages while transmitting its own SL-SR.

4. The control-free SL resource structure allows more resource elements to be used for transmitting PSSCH data TB, and thus achieving lower coding rate and better link performance for SL-SR.

Benefits of allocating data-free SL resources in NR-V2X unicast/groupcast communications include:

1. When the data-free SL resources are used for providing SL-SAs to group member UEs, the group header is able to ensure transmissions from group member UEs do not coincide with the data-free SL resources, so that the provided SL-SAs are “hear-able” by the intended group member UEs.

2. Since the exact timing and SL resource where a group member UE can expect to receive a scheduling response from the group header after sending an SL-SR, if the corresponding SL-SA is not received, the group member UE is able to interpret the sent SL-SR is not received correctly by the group header and immediately re-send the SL-SR without further delay.

3. The data-free SL resource structure allows more than one PSCCH to be transmitted within a single SL resource, and thus achieving multi-UE scheduling and at the same time minimizing SL resource usage from sending SL-SAs in multiple SL resources.

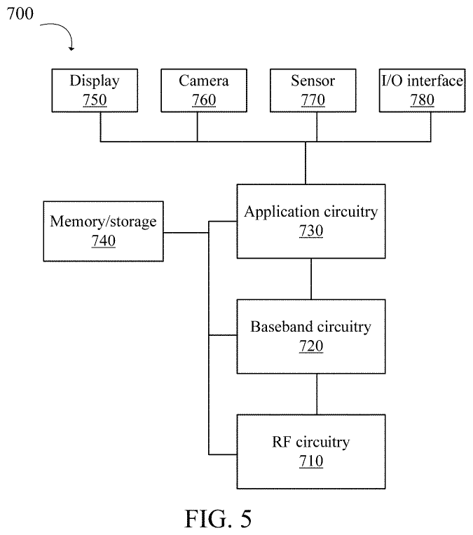

FIG. 5 is a block diagram of a system 700 for wireless communication according to an embodiment of the present disclosure. Embodiments described herein may be implemented into the system using any suitably configured hardware and/or software. FIG. 5 illustrates, for one embodiment, an example system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

In the embodiment of the present disclosure, the apparatus and the method of vehicle-to-everything (V2X) communication of same aim to solve half-duplex (“hear-ability”) and transmission (Tx) collision problems by allocating, to the at least one group member UE of the unicast session or the groupcast session, the at least one set of periodic occurring SL resources over the NR-SL interface, and reserving the at least one set of periodic occurring SL resources over the NR-SL interface from the at least another surrounding UE. The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims

What is claimed is:

1. An apparatus in a vehicle-to-everything (V2X) communication system, the apparatus being a group header of a unicast session or a groupcast session and comprising:
a memory;
a transceiver; and
a processor coupled to the memory and the transceiver,
wherein the processor is configured to:
determine sidelink (SL) resource configuration details;
broadcast, to at least one group member user equipment (UE) of the unicast session or the groupcast session, the SL resource configuration details over a new radio sidelink (NR-SL) interface;
allocate, to the at least one group member UE of the unicast session or the groupcast session, at least one set of periodic occurring SL resources over the NR-SL interface; and
reserve the at least one set of periodic occurring SL resources over the NR-SL interface from at least another surrounding UE.

2. The apparatus of claim 1, wherein the at least one set of periodic occurring SL resources are at least one set of control-free SL resources, and the transceiver is configured to receive at least one SL scheduling request (SL-SR) from the at least one group member UE.

3. The apparatus of claim 1, wherein the SL resource configuration details comprise a set of parameters defining time and frequency locations of the at least one set of control-free SL resources, a modulation and coding scheme (MCS) level, and/or an SL resource structure type.

4. The apparatus of claim 3, wherein the set of parameters of the at least one set of control-free SL resources comprises the time location expressed in a system frame number (SFN) and/or a slot number indicating a starting time or a time offset to a beginning or a next SL resource of the at least one set of control-free SL resources.

5. The apparatus of claim 3, wherein the set of parameters of the at least one set of control-free SL resources comprises the frequency location expressed in a sub-channel index number, a starting physical resource block (PRB) index number, or a bitmap indicating a plurality of PRBs or a plurality of sub-channels within an allocated carrier, a resource pool, and/or a region of the resource pool.

6. The apparatus of claim 2, wherein a structure of the control-free SL resources comprises 3 TDM regions having a first region for automatic gain control (AGC), a second region for PSSCH, and a third region for gap.

7. The apparatus of claim 1, wherein the at least one set of periodic occurring SL resources are at least one set of data-free SL resources, and the transceiver is configured to generate at least one SL scheduling assignment (SL-SA).

8. The apparatus of claim 7, wherein the at least one set of data-free SL resources comprises a set of parameters defining time and frequency locations of the at least one set of data-free SL resources, a modulation and coding scheme (MCS) level, an SL resource structure type, a number of PSCCHs, a PSCCH size, a mapping relationship between the at least one set of control-free SL resources and the at least one set of data-free SL resources, and/or a mapping relationship between the at least one group member UE and the PSCCHs in a data-free SL resource.

9. The apparatus of claim 8, wherein the set of parameters of the at least one set of data-free SL resources comprises the time location expressed in a system frame number (SFN) and/or a slot number indicating a starting time or a time offset to a beginning or a next SL resource of the at least one set of data-free SL resources.

10. The apparatus of claim 8, wherein the set of parameters of the at least one set of data-free SL resources comprises the frequency location expressed in a sub-channel index number, a starting physical resource block (PRB) index number, or a bitmap indicating a plurality of PRBs or a plurality of sub-channels within an allocated carrier, a resource pool, and/or a region of the resource pool.

11. A method of vehicle-to-everything (V2X) communication of an apparatus, the apparatus being a group header of a unicast session or a groupcast session, the method comprising:
determining sidelink (SL) resource configuration details;
broadcasting, to at least one group member user equipment (UE) of the unicast session or the groupcast session, the SL resource configuration details over a new radio sidelink (NR-SL) interface;
allocating, to the at least one group member UE of the unicast session or the groupcast session, at least one set of periodic occurring SL resources over the NR-SL interface; and
reserving the at least one set of periodic occurring SL resources over the NR-SL interface from at least another surrounding UE.

12. The method of claim 11, wherein the at least one set of periodically occurring SL resources are at least one set of control-free SL resources, and the method further comprising receiving at least one SL scheduling request (SL-SR) from the at least one group member UE.

13. The method of claim 11, wherein the SL resource configuration details comprise a set of parameters defining time and frequency locations of the at least one set of control-free SL resources, a modulation and coding scheme (MCS) level, and/or an SL resource structure type.

14. The method of claim 13, wherein the set of parameters of the at least one set of control-free SL resources comprises the time location expressed in a system frame number (SFN) and/or a slot number indicating a starting time or a time offset to a beginning or a next SL resource of the at least one set of control-free SL resources.

15. The method of claim 13, wherein the set of parameters of the at least one set of control-free SL resources comprises the frequency location expressed in a sub-channel index number, a starting physical resource block (PRB) index number, or a bit map indicating a plurality of PRBs or a plurality of sub-channels within an allocated carrier, a resource pool, and/or a region of the resource pool.

16. The method of claim 12, wherein a structure of the control-free SL resources comprises 3 TDM regions having a first region for automatic gain control (AGC), a second region for PSSCH, and a third region for gap.

17. The method of claim 11, wherein the at least one set of periodic occurring SL resources are at least one set of data-free SL resources, and the method further comprising generating at least one SL scheduling assignment (SL-SA).

18. The method of claim 17, wherein the at least one set of data-free SL resources comprises a set of parameters defining time and frequency locations of the at least one set of data-free SL resources, a modulation and coding scheme (MCS) level, an SL resource structure type, a number of PSCCHs, a PSCCH size, a mapping relationship between the at least one set of control-free SL resources and the at least one set of data-free SL resources, and/or a mapping relationship between the at least one group member UE and the PSCCHs in a data-free SL resource.

19. The method of claim 18, wherein the set of parameters of the at least one set of data-free SL resources comprises the time location expressed in a system frame number (SFN) and/or a slot number indicating a starting time or a time offset to a beginning or a next SL resource of the at least one set of data-free SL resources.

20. The method of claim 18, wherein the set of parameters of the at least one set of data-free SL resources comprises the frequency location expressed in a sub-channel index number, a starting physical resource block (PRB) index number, or a bit map indicating a plurality of PRBs or a plurality of sub-channels within an allocated carrier, a resource pool, and/or a region of the resource pool.
